(19) United States
(12) Patent Application Publication
(10) Pub. No.: US 2015/0015617 A1
(43) Pub. Date: Jan. 15, 2015

(54) METHOD AND DEVICE FOR CONTROLLING OPTICAL QUANTITIES OF ORGANIC LIGHT EMISSION DISPLAY DEVICE

(71) Applicant: Samsung Display Co., Ltd., Yongin-City (KR)

(72) Inventors: Yong-Seok YEO, Yongin-City (KR); Sang-Min LIM, Yongin-City (KR); Gee-Bum KIM, Yongin-City (KR)

(73) Assignee: Samsung Display Co., Ltd., Yongin-City (KR)

(21) Appl. No.: 14/201,218

(22) Filed: Mar. 7, 2014

(30) Foreign Application Priority Data
Jul. 9, 2013 (KR) 10-2013-0080545

(51) Int. Cl. G09G 3/20; G09G 3/32

(52) U.S. Cl. CPC G09G 3/2003; G09G 3/3208
USPC 345/690; 345/77

(57) ABSTRACT

A method for controlling optical quantities of an organic light emitting diode (“OLED”) display includes generating an inverse matrix using an initial setting of the OLED display, calculating a variation between the initial setting and a target setting using the target setting, the initial setting and the inverse matrix, where the target setting is input by a user of the OLED, and controlling optical quantities of the OLED display using the variation.

This application claims priority to Korean Patent Application No. 10-2013-0080545, filed on Jul. 9, 2013, and all the benefits accruing therefrom under 35 U.S.C. §119, the content of which in its entirety is herein incorporated by reference.

### BACKGROUND

(a) Field

Exemplary embodiments of the invention relate to a method and device for controlling optical quantities of an organic light emitting diode (“OLED”) display.

(b) Description of the Related Art

Conventionally, optical quantities of an organic light emitting diode (“OLED”) are controlled by trial and error.

However, when the OLED is produced based on the trial and error method, a tact time is increased, accuracy is reduced, thereby deteriorating yield, and the optical quantities of the OLED may not be efficiently or effectively controlled by an ordinary user of the OLED.

### SUMMARY

Exemplary embodiments of the invention provide a device and method for a user of an organic light emitting diode (“OLED”) display to easily control optical quantities of the OLED display.

According to an exemplary embodiment of the invention, a method for controlling optical quantities of an OLED display includes: generating an inverse matrix using an initial setting of the OLED display; calculating a variation between the initial setting and a target setting using the target setting, the initial setting and the inverse matrix, where the target setting is input by a user of the OLED; and controlling optical quantities of the OLED display using the variation.

In an exemplary embodiment, the generating the inverse matrix may include: acquiring a changed setting by changing red data, green data and blue data of the initial setting; and calculating the inverse matrix using the changed setting and the initial setting.

In an exemplary embodiment, the acquiring the changed setting may include: acquiring a first modification setting by changing the red data of the initial setting; acquiring a second modification setting by changing the green data of the initial setting; and acquiring a third modification setting by changing the blue data of the initial setting.

In an exemplary embodiment, the calculating the inverse matrix may include: generating a matrix by calculating differences in color coordinates and a luminance value between the initial setting and the first modification setting, differences in the color coordinates and the luminance value between the initial setting and the second modification setting, and differences in the color coordinates and the luminance value between the initial setting and the third modification setting; and calculating an inverse of the matrix.

In an exemplary embodiment, the calculating the variation may include generating a difference matrix by calculating differences in color coordinates and a luminance value between the target setting and the initial setting; and calculating the variation using the inverse matrix and the difference matrix.

According to another embodiment of the invention, a device for controlling optical quantities of an OLED display includes: an inverse matrix generator which generates an inverse matrix using an initial setting of the OLED display; a variation calculator which calculates a variation between the initial setting and a target setting using a target setting, the initial setting and the inverse matrix, where the garget setting is input by a user of the OLED; and a panel controller which controls optical quantities of the OLED display using the variation.

In an exemplary embodiment, the inverse matrix generator may acquire a changed setting by changing red data, green data and blue data of the initial setting, and the inverse matrix generator may calculate the inverse matrix using the changed setting and the initial setting.

In an exemplary embodiment, the changed setting may include a first modification setting acquired by changing the red data, a second modification setting acquired by changing the green data, and a third modification setting acquired by changing the blue data.

In an exemplary embodiment, the inverse matrix generator may calculate a matrix using differences in color coordinates and a luminance value between the initial setting and the first modification setting, differences in color coordinates and a luminance value between the initial setting and the second modification setting, and differences in color coordinates and a luminance value between the initial setting and the third modification setting, and the inverse matrix generator may calculate an inverse of the matrix.

In an exemplary embodiment, the variation calculator may generate a difference matrix using differences in color coordinates and a luminance value between the target setting and the initial setting, and the variation calculator may calculate the variation using the inverse matrix and the difference matrix.

According to another embodiment of the invention, an OLED display with controllable optical quantities includes: a display panel including an OLED; and an optical quantities control device which controls optical quantities of the display panel, where the optical quantities control device includes an inverse matrix generator which generates an inverse matrix using an initial setting of the OLED display, a variation calculator which calculates a variation between the initial setting and the target setting using a target setting, the initial setting and the inverse matrix, where the garget setting is input by a user of the OLED, and a panel controller which controls the optical quantities of the OLED display using the variation.

According to exemplary embodiments of the invention, the user of the OLED display may easily control the optical quantities of the OLED display without using a special device such as a luminance gauge. In such embodiments, when the optical quantities control device may include a multiple time programmable (“MTP”) chip, the tact time is substantially reduced and the optical quantities of the OLED display are substantially effectively controlled.

### BRIEF DESCRIPTION OF THE DRAWINGS

The above and other features of the invention will become more apparent by describing in detail exemplary embodiments thereof with reference to the attached drawings, in which:

FIG. 1 is a block diagram showing an exemplary embodiment of an organic light emitting diode (“OLED”) display according to the invention;

FIG. 2 is a block diagram showing an exemplary embodiment of an optical quantities control device of an OLED display according to the invention; and

FIG. 3 is a flowchart showing an exemplary embodiment of a method of changing an optical quantity of an OLED display according to the invention.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

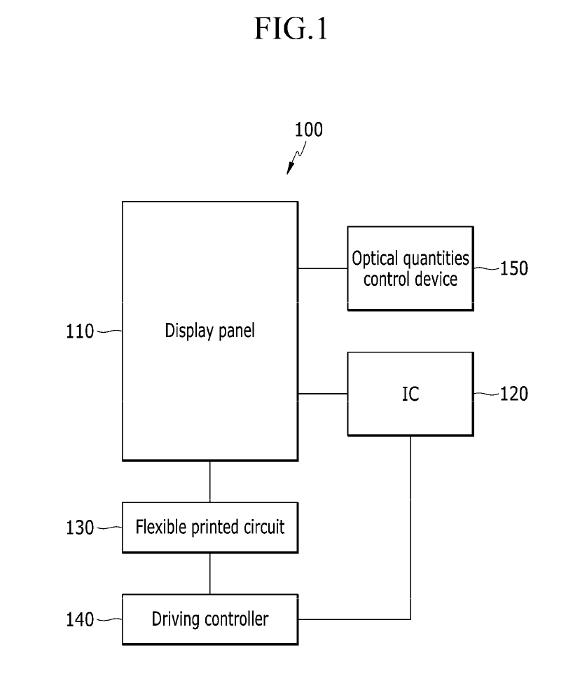

FIG. 1 is a block diagram showing an exemplary embodiment of an organic light emitting diode (“OLED”) display according to the invention.

Referring to FIG. 1, an exemplary embodiment of the OLED display 100 includes a display panel 110, an integrated circuit 120 (referred to as “IC” in FIG. 1), a flexible printed circuit 130, a driving controller 140 and an optical quantities control device 150. In such an embodiment, the display panel 110, the integrated circuit 120 and the flexible printed circuit 130 may be disposed in a display module, and the driving controller 140 may be disposed in a module control set.

The driving controller 140 may transmit drive control signals such as a video signal, a synchronization signal and a clock signal, for example, to the integrated circuit 120 and the flexible printed circuit 130. The display panel 110 may display an image based on a display control signal provided by the integrated circuit 120 and the flexible printed circuit 130.

In an exemplary embodiment, the optical quantities control device 150 generates an optical quantities control signal, and transmits the optical quantities control signal to the display panel 100. In one exemplary embodiment, for example, the optical quantities control device 150 may load an optical quantities control signal to the display control signal from the integrated circuit 120 or the flexible printed circuit 130, and transmit the optical quantities control signal and the display control signal to the display panel 110. In such an embodiment, the optical quantities control device 150 may be disposed in the integrated circuit 120 or the driving controller 140. In an alternative exemplary embodiment, the optical quantities control device 150 may be disposed between the driving controller 140 and the display panel 110 as a separate module.

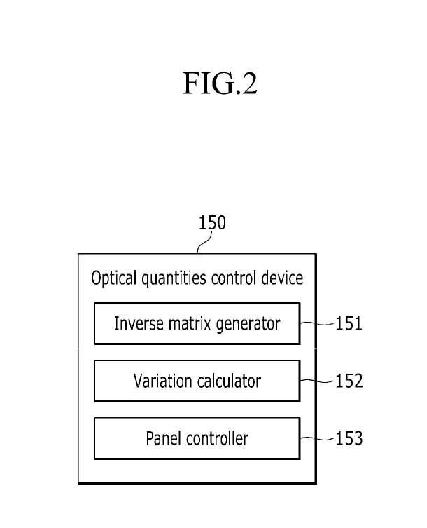

FIG. 2 is a block diagram showing an exemplary embodiment of the optical quantities control device of an OLED display according to the invention.

Referring to FIG. 2, an exemplary embodiment of the optical quantities control device 150 of the OLED display 100 includes an inverse matrix generator 151, a variation calculator 152 and a panel controller 153.

The inverse matrix generator 151 calculates an inverse matrix for calculating red, green and blue (“RGB”) data of a target setting using a predetermined initial setting, and transmits the calculated inverse matrix to the variation calculator 152. In an exemplary embodiment, the initial setting may be set when the OLED display is produced in a factory.

The variation calculator 152 calculates a variation on the target setting using the inverse matrix calculated by the inverse matrix generator 151 and using color coordinates and a luminance value, which may be provided or set by a user of the OLED display 100. In an exemplary embodiment, the color coordinates and the luminance value may be changed based on a control of the user of the OLED display 100.

The panel controller 153 changes a current setting of the OLED display 100 based on a variation of the target setting.

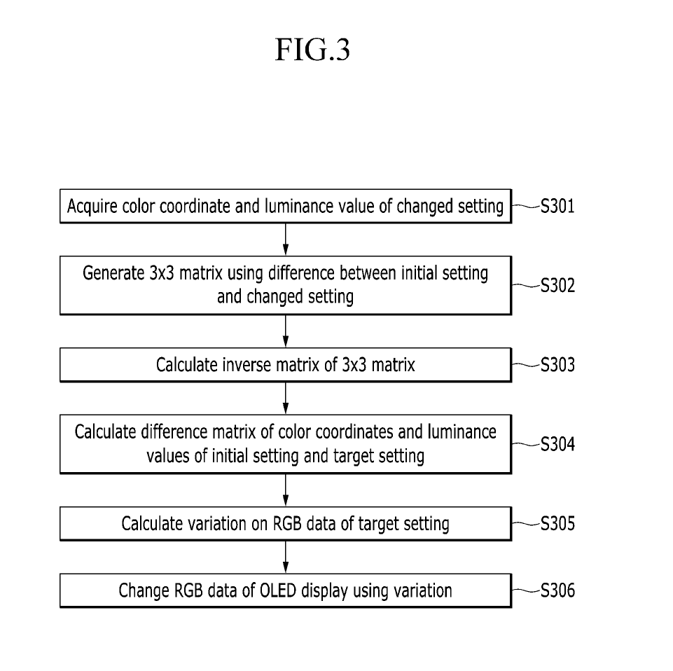

An exemplary embodiment of a method of changing the optical quantities of the OLED display 100 using the optical quantities control device 150 by the user will now be described with reference to FIG. 3.

FIG. 3 is a flowchart showing an exemplary embodiment of a method of changing an optical quantity of an OLED display according to the invention.

Referring to FIG. 3, the inverse matrix generator 151 acquires the color coordinates and the luminance value of a changed setting by changing red (“R”) data, green (“G”) data, and blue (“B”) data from the RGB data of the initial setting of the OLED display, and (S301).

The following Table 1 shows an initial setting of an exemplary embodiment of the OLED display, and the initial setting includes gamma data (e.g., RGB data) allocated to the RGB pixels in 255 grayscales, and color coordinates (x, y) and a luminance value Y mapping the RGB data. In Table 1, the RGB data are expressed using hexadecimal digits.

TABLE 1

| | | | |
|---|---|---|---|
| R | 0xb9 | x | 0.2807 |
| G | 0xb8 | y | 0.2571 |
| B | 0xfc | Y | 218 |

In an exemplary embodiment, the inverse matrix generator 151 changes the R data, the G data and the B data of the initial setting shown in Table 1, and thereby acquires the changed setting. In such an embodiment, the inverse matrix generator 151 may randomly change the R data, the G data and the B data to acquire the modified setting, but a method for changing the R data, the G data and the B data in the exemplary embodiment of the invention is not limited thereto. The following Table 2 to Table 4 show changed settings acquired from the initial setting of Table 1.

TABLE 2

| | | | |
|---|---|---|---|
| R | 0xb7 | x | 0.2775 |
| G | 0xb8 | y | 0.2565 |
| B | 0xfc | Y | 216 |

TABLE 3

| | | | |
|---|---|---|---|
| R | 0xb9 | x | 0.2813 |
| G | 0xb6 | y | 0.2537 |
| B | 0xfc | Y | 214 |

TABLE 4

| | | | |
|---|---|---|---|
| R | 0xb9 | x | 0.2825 |
| G | 0xb8 | y | 0.2599 |
| B | 0xfa | Y | 217.8 |

Table 2 shows the color coordinates and luminance when the R data of

Table 1 are modified, e.g., modified into 0xb7 from 0xb9. In Table 2, when the R data of the initial setting are modified into 0xb7 from 0xb9, the color coordinates become (0.2775, 0.2565), that is, x=0.2775 and y=0.2565, and the luminance becomes 216 (i.e., Y=216). Table 3 shows the color coordinates and luminance when the G data of Table 1 are modified, e.g., modified into 0xb6 from 0xb8. In Table 3, when the G data of the initial setting are modified into 0xb6 from 0xb8, the color coordinates become (0.2813, 0.2537), that is, x=0.2813 and y=0.2537, and the luminance becomes 214 (i.e., Y=214). Table 4 shows the color coordinates and luminance when the B data of Table 1 are modified, e.g., modified into 0xfa from 0xfc. In Table 4, when the B data of the initial setting is modified into 0xfa from 0xfc, the color coordinates become (0.2825, 0.2599), that is, x=0.2825 and y=0.2599, and the luminance becomes 217.8 (i.e., Y=217.8).

In an exemplary embodiment, the inverse matrix generator 151 generates a 3×3 matrix using a difference between the initial setting and the changed settings (S302). In such an embodiment, the difference between the color coordinates and the luminance value of Table 1 and Table 2 is written in a first row of the 3×3 matrix, the difference between the color coordinates and the luminance value of Table 1 and Table 3 is written in a second row of the 3×3 matrix, and the difference between the color coordinates and the luminance value of Table 1 and Table 4 is written in a third row of the 3×3 matrix.

In such an embodiment, the first row of the 3×3 matrix represents a change in the coordinate x when R data are modified, a change in the coordinate x when the G data are modified, and a change in the coordinate x when the B data are modified.

In such an embodiment, the second row of the 3×3 matrix represents a change in the coordinate y when the R data are modified, a change in the coordinate y changes when the G data are modified, and a change in the coordinate y when the B data are modified.

In such an embodiment, the third row of the 3×3 matrix represents a change in the luminance Y when the R data are modified, a change in the luminance Y when the G data are modified, and a change in the luminance Y when the B data are modified.

The matrix of the following Equation 1 shows the 3×3 matrix generated by the inverse matrix generator 151.

$${X}_{255} = [ \begin{matrix}- 0.0032 & 0.0006 & 0.0018 \\ - 0.0006 & - 0.0034 & 0.0028 \\ - 2 & - 4 & - 0.2\end{matrix} ] \qquad Equation 1$$

The inverse matrix generator 151 calculates an inverse matrix of the 3×3 matrix (S303). The matrix of the following Equation 2 is an inverse matrix of the 3×3 matrix generated by the inverse matrix generator 151.

$${X}_{255}^{- 1} = [ \begin{matrix}- 361.4623 & 288.62012 & - 0.787521 \\ 151.18197 & - 101.7042 & 0.0632216 \\ - 590.9841 & 852.11655 & - 1.610775\end{matrix} ] \qquad Equation 2$$

In such an embodiment, a first row of the inverse matrix generated by the inverse matrix generator 151 represents a change in the R data to modify the coordinate x, a change in the G data to modify the coordinate x, and a change in the B data to modify the coordinate x.

In such an embodiment, a second row of the inverse matrix generated by the inverse matrix generator 151 represents a change in the R data to modify the coordinate y, a change in the G data to modify the coordinate y, and a change in the B data to modify the coordinate y.

In such an embodiment, a third row of the inverse matrix generated by the inverse matrix generator 151 represents a change in the R data to modify the luminance Y, a change in the G data to modify the luminance Y, and a change in the B data to modify the luminance Y.

In an exemplary embodiment, the optical quantities control device 150 uses the inverse matrix calculated from the 255 grayscales to modify the RGB data in 172 grayscales into RGB data in 255 grayscales.

In an alternative exemplary embodiment, the inverse matrix generator 151 may generate the inverse matrix for RGB data in other grayscales through the initial setting and the changed setting including a plurality of modification settings, e.g., a first modification setting, a second modification setting and a third modification setting, as shown in the following Table 5 and Table 6. Table 5 shows the initial setting and the changed setting of 171 grayscales, and Table 6 shows the initial setting and the changed setting of for RGB data in 87 grayscales.

TABLE 5

| | | | | |
|---|---|---|---|---|
| Initial setting | R | 0xc5 | x | 0.2933 |
| | G | 0xc7 | y | 0.3332 |
| | B | 0xb5 | Y | 138 |
| Modification setting 1 | R | 0xc3 | x | 0.2897 |
| (R data change) | G | 0xc7 | y | 0.3332 |
| | B | 0xb5 | Y | 136.7 |
| Modification setting 2 | R | 0xc5 | x | 0.2945 |
| (G data change) | G | 0xc5 | y | 0.3282 |
| | B | 0xb5 | Y | 134.7 |
| Modification setting 3 | R | 0xc5 | x | 0.2957 |
| (B data change) | G | 0xc7 | y | 0.338 |
| | B | 0xb3 | Y | 137.8 |

The following Equation 3 shows an inverse matrix calculated from the initial setting and the changed setting of for RGB data in 171 grayscale based on Table 5.

$${X}_{171}^{- 1} = [ \begin{matrix}- 201.1659 & 91.743119 & - 0.212156 \\ 74.541284 & - 45.87156 & - 0.206422 \\ 77.647171 & 160.55046 & - 0.215023\end{matrix} ] \qquad Equation 3$$

According to an exemplary embodiment of the invention, the user may use the inverse matrix calculated from the initial setting and the changed setting of for RGB data in 171 grayscales to change the color coordinates and the luminance in 88 grayscales to 171 grayscales.

TABLE 6

| | | | | |
|---|---|---|---|---|
| Initial setting | R | 0xb5 | x | 0.3093 |
| | G | 0xb8 | y | 0.3673 |
| | B | 0xa5 | Y | 37.9 |
| Modification setting 1 | R | 0xb3 | x | 0.3049 |
| (R data change) | G | 0xb8 | y | 0.368 |
| | B | 0xa5 | Y | 37.4 |
| Modification setting 2 | R | 0xb5 | x | 0.3116 |
| (G data change) | G | 0xb6 | y | 0.361 |
| | B | 0xa5 | Y | 36.6 |
| Modification setting 3 | R | 0xb5 | x | 0.3124 |
| (B data change) | G | 0xb8 | y | 0.3731 |
| | B | 0xa3 | Y | 37.8 |

The following Equation 4 shows the inverse matrix calculated from the initial setting and the changed setting for RGB data in 87 grayscales based on Table 6.

$${X}_{87}^{- 1} = [ \begin{matrix}- 148.4294 & 69.036935 & - 0.597169 \\ 51.414349 & - 36.15355 & - 0.503061 \\ 73.760515 & 124.81151 & - 0.474356\end{matrix} ] \qquad Equation 4$$

According to an exemplary embodiment of the invention, the user may use the inverse matrix calculated from the initial setting and the changed setting for RGB data in 87 grayscales to change the color coordinates and the luminance of RGB data in 44 grayscales to 87 grayscales.

In an exemplary embodiment, as described above, the inverse matrix may be calculated from an initial setting and a changed setting of RGB data in predetermined grayscales, and the user may control or change the color coordinates and the luminance of RGB through the calculated inverse matrix.

The variation calculator 152 calculates a variation on the RGB data of the target setting using the inverse matrix calculated by the inverse matrix generator 151 and the target setting provided by the user, e.g., the color coordinates and the luminance value thereof.

In one exemplary embodiment, for example, when the user inputs the color coordinates and the luminance value of the target setting as in the following Table 7, the variation calculator 152 calculates differences in the color coordinates and the luminance value between the target setting and the initial setting in 255 grayscales (S304). In such an embodiment, the variation calculator 152 calculates a variation on the RGB data of the target setting (e.g., a variation matrix) by multiplying a difference matrix corresponding to the calculated differences in the color coordinates and the luminance value by the inverse matrix of 255 grayscales as represented by the following Equation 5 (S305).

TABLE 7

| Color coordinates and lumi- | | Color coordinates and lumi- | | |
|---|---|---|---|---|
| nance value of target setting | | nance value of initial setting | | Difference |
| x | 0.286 | x | 0.2807 | 0.0053 |
| y | 0.312 | y | 0.2571 | 0.0549 |
| Y | 200 | Y | 218 | −18 |

$${X}_{255}^{- 1} [ \begin{matrix}0.0053 \\ 0.0549 \\ - 18\end{matrix} ] = {M}_{var} [ \begin{matrix}- 361.4623 & 288.62012 & - 0.787521 \\ 151.18197 & - 101.7042 & 0.0632216 \\ - 590.9841 & 852.11655 & - 1.610775\end{matrix} ] [ \begin{matrix}0.0053 \\ 0.0549 \\ - 18\end{matrix} ] = [ \begin{matrix}9.442 \\ - 1.228 \\ 20.139\end{matrix} ] \qquad Equation 5$$

In Equation 5 above, Mᵥₐᵣ denotes the variation matrix for the RGB data of the target setting.

The variation calculator 152 transmits the variation matrix to the panel controller 153, and the panel controller 153 changes the RGB data of the OLED display 100 based on the variation matrix (S306).

In such an embodiment, the panel controller 153 may be controlled to maintain the modified setting by the user. In such an embodiment, the user may check an image displayed based on the modified setting and may maintain the modified setting or return to the initial setting.

According to exemplary embodiments of the invention, as described herein, the user of the OLED display may efficiently or effectively change the optical quantities of the OLED display without using an additionally provided device such as a luminance gauge. In such embodiments, the optical quantities control device is applied to a multiple time programmable (“MTP”) chip, such that the tact time is substantially reduced, and the panel is accurately controlled.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling optical quantities of an organic light emitting diode display, the method comprising:
generating an inverse matrix using an initial setting of the organic light emitting diode display;
calculating a variation between the initial setting and a target setting using the target setting, the initial setting and the inverse matrix, wherein the target setting is input by a user of the organic light emitting diode display; and
controlling the optical quantities of the organic light emitting diode display using the variation.

2. The method of claim 1, wherein the generating the inverse matrix comprises:
acquiring a changed setting by changing red data, green data and blue data of the initial setting; and
calculating the inverse matrix using the changed setting and the initial setting.

3. The method of claim 2, wherein the acquiring the changed setting comprises:
acquiring a first modification setting by changing the red data of the initial setting;
acquiring a second modification setting by changing the green data of the initial setting; and
acquiring a third modification setting by changing the blue data of the initial setting.

4. The method of claim 3, wherein the calculating the inverse matrix comprises:
generating a matrix by calculating differences in color coordinates and a luminance value between the initial setting and the first modification setting, differences in the color coordinates and the luminance value between the initial setting and the second modification setting, and differences in the color coordinates and the luminance value between the initial setting and the third modification setting; and
calculating an inverse of the matrix.

5. The method of claim 1, wherein the calculating the variation comprises:
generating a difference matrix by calculating differences in color coordinates and a luminance value between the target setting and the initial setting; and
calculating the variation using the inverse matrix and the difference matrix.

6. A device for controlling optical quantities of an organic light emitting diode display, the device comprising:
an inverse matrix generator which generates an inverse matrix using an initial setting of the organic light emitting diode display;
a variation calculator which calculates a variation between the initial setting and a target setting using the target setting, the initial setting and the inverse matrix, wherein the garget setting is input by a user of the organic light emitting diode display; and
a panel controller which controls the optical quantities of the organic light emitting diode display using the variation.

7. The device of claim 6, wherein
the inverse matrix generator acquires a changed setting by changing red data, green data and blue data of the initial setting, and
the inverse matrix generator calculates the inverse matrix using the changed setting and the initial setting.

8. The device of claim 7, wherein
the changed setting comprises:
a first modification setting acquired by changing the red data;
a second modification setting acquired by changing the green data; and
a third modification setting acquired by changing the blue data.

9. The device of claim 8, wherein
the inverse matrix generator calculates a matrix using differences in color coordinates and a luminance value between the initial setting and the first modification setting, differences in color coordinates and a luminance value between the initial setting and the second modification setting and differences in color coordinates and a luminance value between the initial setting and the third modification setting, and
the inverse matrix generator calculates an inverse of the matrix.

10. The device of claim 6, wherein
the variation calculator generates a difference matrix using differences in color coordinates and a luminance value between the target setting and the initial setting, and
the variation calculator calculates the variation using the inverse matrix and the difference matrix.

11. An organic light emitting diode display comprising:
a display panel comprising an organic light emitting diode; and
an optical quantities control device which controls optical quantities of the display panel,
wherein the optical quantities control device comprises:
an inverse matrix generator which generates an inverse matrix using an initial setting of the organic light emitting diode display;
a variation calculator which calculates a variation between the initial setting and a target setting using the target setting, the initial setting and the inverse matrix, wherein the garget setting is input by a user of the organic light emitting diode display; and
a panel controller which controls the optical quantities of the organic light emitting diode display using the variation.

12. The organic light emitting diode display of claim 11, wherein
the inverse matrix generator acquires a changed setting by changing red data, green data and blue data of the initial setting, and
the inverse matrix generator calculates the inverse matrix using the changed setting and the initial setting.

13. The organic light emitting diode display of claim 12, wherein the changed setting comprises:
a first modification setting acquired by changing the red data;
a second modification setting acquired by changing the green data; and
a third modification setting acquired by changing the blue data.

14. The organic light emitting diode display of claim 13, wherein
the inverse matrix generator calculates a matrix using differences in color coordinates and a luminance value between the initial setting and the first modification setting, differences in color coordinates and a luminance value between the initial setting the second modification setting and differences in color coordinates and a luminance value between the initial setting and the third modification setting, and
the inverse matrix generator calculates an inverse of the matrix.

15. The organic light emitting diode display of claim 11, wherein
the variation calculator generates a difference matrix using differences in color coordinates and a luminance value between the target setting and the initial setting, and
the variation calculator calculates the variation using the inverse matrix and the difference matrix.
